(19) United States
(12) Patent Application Publication
(10) Pub. No.: US 2008/0252763 A1
(43) Pub. Date: Oct. 16, 2008

(54) Spatial noise reduction in CMOS imagers

(76) Inventor: Moti Shefer, Tel Aviv (IL)

Correspondence Address: MOTI SHEFER, POBox 29746, TEL AVIV, 61297, IL

(21) Appl. No.: 11/786,470

(22) Filed: Apr. 12, 2007

(51) Int. Cl. H04N 5/335

(52) U.S. Cl. 348/308; 348/E05.091

(57) ABSTRACT

The spatial, so-called: “fixed-pattern” noise of matrix image sensors is reduced via on-line normalization of each pixel's photo-transmission to its own average reset noise. Said normalization is performed per each frame anew.

### 1. BACKGROUND OF THE INVENTION AND PRIOR ART

The noise generated by array imagers imposes the main limit on the image quality they can produce. There are two kinds of imager noise: temporal noise and spatial noise. The temporal noise is an inherent property of each and every single pixel of the array. The spatial noise, sometimes referred to as fixed-pattern noise (FPN) reflects the pixel-to-pixel transmission non-uniformities to noise and photo-signal, both present at the light detecting element which is the pixel's front element. Therefore, the spatial noise is only present at the output of array imagers, whereas the temporal noise is a single-pixel property.

In modern CMOS imagers, it has been commonly experienced that the FPN is several orders of magnitude larger than the temporal noise. The purpose of the present invention is therefore to reduce the FPN so as to bring it down to the level of the single pixel noise, thereby typically achieving 6 to 10 bits of additional dynamic range (factor 64 to factor 1,000) relative to today's CMOS imagers.

It has been identified by the imaging industry that the main contributor to FPN is manifested by non-uniformities in the reset noise of the pixels. Accordingly, the double-correlated-sampling (DCS), sometimes referred to as the four-transistor (4T) configuration, has been invented and widely applied to CMOS imagers. The essence of DCS is measuring each pixel's reset noise right before the light integration begins and subtracting said reset noise sample from its own pixel's output at the end of the light integration period, i.e., at each pixel's readout time. This technique has been shown to yield a very significant reduction of FPN in the very dark areas of the image.

However, DCS does not significantly reduce FPN for the medium and high luminance areas of the picture; thereby its effect on the imager's dynamic range is limited.

To reduce light-dependent FPN (sometimes referred to as PRNU), the 2-point correction method is traditionally applied to high-end imagers. The 2-point correction is based on in-production measurements of each pixel's response to at least one light-level, say ⅔ of the full scale. These measured values are provided to the customer together with the imager chip so that based on each pixel's response to full darkness and said measurements, the user can normalize every pixel's response and have a larger uniformity across the array. The disadvantages of the 2-point correction are significant increase of cost of production and use of the imager, and imperfections in the correction due to variations of pixels transmissions in time and with temperature.

### 2. THE PRESENT INVENTION—SPATIAL NOISE REDUCTION VIA ON-LINE NORMALIZATION

The present invention is based on the fact that in modern CMOS imagers, if the reset period is long enough (longer than 1.0 msec), and if the pixel's channel noise-figure is close enough to unity, then the average reset noise at the pixel's channel output at the end of the reset period is proportional to the pixel response to both white noise and photon-flux, which are present at the pixel's front-end photodiode. Hence, if one divides each pixel's response to light by its long-period average reset noise, this should normalize each pixel response to an identical, pixel invariant response, thereby eliminating both FPN and PRNU.

In order to mechanize the present invention, three novel operations must take place:
1. The pixel's reset period should be increased from the traditional order of 10⁻⁶ (microseconds) to 10⁻³ (milliseconds).
2. Each pixel's output should be readout, sampled and stored twice in every frame period. The first pixel readout is its average reset noise, which should take place at the end of the pixel's reset period, and the second pixel readout should take place at the end of the pixel's light-integration period.
3. With the two operations above, there are now two equi-size images stored, preferably in a digital memory. The first picture consists of the average reset noises of the pixels, and it is actually proportional to the fixed-pattern noise that belongs to the very picture of the particular frame being taken. The second picture is the actual photographed frame. The third operation of the present invention is, for each and every frame, to divide the photographed frame by its associated noise frame, said division is done anew per each frame, and made in a pixel to pixel correspondence, i.e., each picture pixel value is divided by the value of the corresponding noise pixel.

1. Reduction of spatial noise of CMOS imagers via a division of the value of every pixel of the photographed scenario by the value of the corresponding pixel of the reset noise image.

2. claim 1, where said reset noise image is obtained by sampling of each pixel's output at the end of the reset period and before the light integration begins.

3. claim 2, where the reset period is increased from the traditional value of order 10⁻⁶ (microseconds) to order 10⁻³ (milliseconds).

4. claims 1, 2, 3, where said operations are performed anew per every frame of a video sequence.
